(19) United States
(12) Patent Application Publication
(10) Pub. No.: US 2023/0003130 A1
(43) Pub. Date: Jan. 5, 2023

(54) TURBOMACHINE BLADE SYSTEM

(71) Applicant: MTU Aero Engines AG, Muenchen (DE)

(72) Inventor: Richard Scharl, Karlsfeld (DE)

(21) Appl. No.: 17/942,502

(22) Filed: Sep. 12, 2022

Related U.S. Application Data
(63) Continuation of application No. 15/818,053, filed on Nov. 20, 2017.

(30) Foreign Application Priority Data
Nov. 21, 2016 (DE) 102016222869.2

(51) Int. Cl. F01D 5/16; F01D 25/04; F04D 29/66; F01D 25/06; F01D 5/26

(52) U.S. Cl. CPC F01D 5/16; F01D 25/04; F04D 29/668; F01D 25/06; F01D 5/26; F05D 2230/50; F04D 29/324

(57) ABSTRACT

A turbomachine blade system, in particular for a compressor or turbine stage of a gas turbine, which includes at least one blade, in particular a moving or guide blade, and at least one moving body for reducing the vibrations of this blade, at least one area of a guide for guiding the body and/or at least one area of a supporting structure for resiliently mounting the body and/or at least one area of the body being or becoming generatively manufactured together with at least one area of the blade, in particular of a vane and/or blade root and/or a shroud situated thereon.

This is a continuation of U.S. application Ser. No. 15/818,053 filed on Nov. 20, 2017, published as US 2018/0142558 A1 on May 24, 2018 and claims the benefit of German Patent Application DE 102016222869.2, filed Nov. 21, 2016. Both applications are hereby incorporated by reference herein.

The present invention relates to a turbomachine blade system, a turbomachine, in particular a gas turbine, which includes the turbomachine blade system, and a method for manufacturing the turbomachine blade system.

### BACKGROUND

From WO 2012/095067 A1 of the applicant, situating tuning bodies or impulse bodies in a blade root or a vane of a gas turbine blade, which are provided for impact contact with the blade, is known. A new concept of the applicant may be implemented hereby to reduce undesirable vibrations, which is essentially based not on friction dissipation but on a detuning of eigenforms and eigenfrequencies by impacts of the impulse body.

The applicant's DE 10 2009 010 185 A1 proposes to provide multiple damping bodies in a cavity in an inner or outer ring of a blade cluster, which dissipate vibration energy during frictional impacts against one another and against the cavity.

A turbomachine moving blade system, including a cavity, is known from U.S. Pat. No. 9,371,733 B2 of the applicant, in which a tuning mass is movably situated.

### SUMMARY OF THE INVENTION

It is one object of the present invention to provide an improved turbomachine blade system.

The present invention provides a turbomachine blade system. A turbomachine, which includes at least one turbomachine blade system described herein, and a method for manufacturing a turbomachine blade system described herein is also provided.

According to one embodiment of the present invention, a turbomachine blade system, in particular for a compressor or turbine stage of a gas turbine, in particular of an aircraft engine, includes, in particular, at least one turbomachine blade system of a turbomachine, in particular of at least one compressor or turbine stage of a gas turbine, in particular of an aircraft engine, at least one blade, in particular a moving or guide blade, and one or multiple moving bodies for reducing the vibrations of this blade.

In one embodiment, the body or bodies is/are so-called impulse bodies, which reduce the vibrations of the blade through multiple, in particular stochastic or chaotic and/or elastic, in particular at least essentially fully elastic, impact contacts with the blade, in particular an inner wall of the blade, or which are provided or configured or used for this purpose.

Likewise, the body or bodies may also be provided or configured or used to reduce vibrations with the aid of friction dissipation, in particular on an inner wall of the blade and/or in a liquid.

The body or bodies and/or the blade may furthermore be tuned to reduce vibrations in such a way that the body or bodies abut an inner wall of the blade in a predefined first operating state of the turbomachine and detach from the inner wall, at least temporarily, in a second predefined operating state, to reduce vibrations of the blade.

In this regard, reference is additionally made to WO 2012/095067 A1, DE 10 2009 010 185 A1 and U.S. Pat. No. 9,371,733 B2 mentioned at the outset, and their content is expressly included in the present disclosure.

In one embodiment the body or one or multiple of the bodies (each) have a mass which is at least 0.01 gram (g), in particular at least 0.1 g, and/or at most 1 g, in particular 0.5 g.

In one embodiment, the body or one or multiple of the bodies (each) additionally or alternatively has/have an, in particular, minimum or maximum outer dimension, which is at least 1 mm and/or at most 10 mm, in particular at most 5 mm, in particular at 20° C.

It has surprisingly been proven that, due to these parameters or limiting values, a particularly advantageous reduction in vane vibrations may be achieved individually, in particular, however, in combination.

According to one embodiment of the present invention, the turbomachine blade system includes a single- or multi-part (elastic) supporting structure, which resiliently or elastically mounts or supports, in particular restrains or connects, the body or bodies, or is provided or configured or used for this purpose or with the aid of which the body or bodies is/are resiliently or elastically mounted or supported or restrained or connected. In one refinement, a minimum wall thickness of the elastic supporting structure is at most 50%, in particular at most 10% and/or at least 1% of a maximum outer dimension of the body.

In one embodiment, the action, in particular the kinematics and/or dynamics, of the body or bodies may be improved hereby, for example its/their movement storage, in particular impact energy storage and the like.

According to one embodiment of the present invention, the turbomachine blade system additionally or alternatively includes a single- or multi-part guide, which guides the body or bodies, in particular in such a way that it has a clearance limited in one or multiple translatory and/or one or multiple rotational degrees of freedom, in particular for the purpose of multiple impact contacts with the blade, while its remaining degrees of freedom are blocked by the guide, or which is provided or configured or used for this purpose or via which the body or bodies is/are (correspondingly) guided.

In one embodiment, a maximum translatory clearance of the one or multiple body/bodies is (in each case) at least 0.01 mm, in particular at least 0.1 mm and/or at least 1% of a minimum outer dimension of this body, and/or at most 10 mm, in particular at most 1 mm and/or at most 100% of a maximum outer dimension of this body, in particular at 20° C.

In one embodiment, the action, in particular the kinematics and/or dynamics, of the body or bodies may be (further) improved hereby, for example the (main) impact direction(s), maximum (movement) path length(s) and the like.

In one refinement, the body or bodies is/are designed to be unrestrained or disconnected or not connected by the guide, in particular elastically mounted or non-elastically mounted.

In one embodiment, the action, in particular dynamics, of the body or bodies may be (further) improved hereby, for example impact contacts may be (more greatly) varied and the like.

In one embodiment, the blade includes a vane for deflecting the flow and/or a blade root, via which the blade may, in one refinement, be or become indestructibly detachably or non-indestructibly detachably connectable or connected to a housing or rotor of the turbomachine. Likewise, the blade, in particular its blade root, may be designed to be integral with the housing or rotor, in particular, therefore, as a so-called “BLISK.” In one embodiment, a shroud is situated on the vane, in particular its end facing the blade root and/or facing away therefrom, or radially inwardly and/or outwardly (in each case)—with respect to a main or machine (rotation) axis of the turbomachine—in particular integrally connected to the vane or, in particular, non-indestructibly detachably connected thereto.

According to one embodiment of the present invention, the complete guide for guiding the body or the bodies, or a part of the guide, is or will be generatively manufactured together or jointly, in particular integrally, with the complete blade, in particular its vane and/or root and/or shroud, or a part thereof.

According to one embodiment of the present invention, the complete supporting structure for resiliently mounting the body or the bodies, or a part of the supporting structure, additionally or alternatively is generatively manufactured together or jointly, in particular integrally, with the complete blade, in particular its vane and/or blade root and/or shroud, or a part thereof, and in one refinement, integrally with the complete body/bodies or (one) part(s) thereof.

According to one embodiment of the present invention, the body or one or multiple of the bodies, in particular impulse bodies, additionally or alternatively is/are partially or completely (in each case) generatively manufactured together or jointly, in particular integrally, with the complete blade, in particular its vane and/or blade root and/or shroud, or a part thereof.

A jointly generatively manufactured area of the blade, guide, supporting structure or the body or bodies may thus, in one embodiment, be or designate a (genuine) part (partial area) or, in another embodiment, also the complete blade, guide, supporting structure or complete body or bodies. In the present case, therefore, “at least one area” is referred to, in particular, for the purpose of a more compact illustration.

In one embodiment, the body or bodies may be advantageously captively secured by the joint generative manufacture of the blade (area) and guide (area), supporting structure (area) or body (area(s)). Additionally or alternatively, advantageous, in particular complex, blades, guides, supporting structures or bodies may be manufactured hereby, and, in particular, the action, in particular the kinematics and/or dynamics, of the body or bodies may thus be (further) improved, for example transmissions of force, clearances and the like.

In one embodiment, the generative or additive manufacture includes, in a manner which is known per se, the layer-by-layer manufacture with the aid of repeated arrangement, in particular of liquid and/or loose, in particular granular or powdered, source material on a previously (solidified) layer and local solidification and/or at least partial bonding therewith, in particular chemically and/or physically, in particular with the aid of energy input, in particular thermally and/or electromagnetically, in particular optically, in particular by exposure, in particular with the aid of laser (light).

In one embodiment, the area of the blade jointly generatively manufactured with the guide (area), supporting structure (area) or body (area(s)) has a contact surface which contacts the body or bodies, in particular temporarily, in particular multiple times and/or abruptly, during the operation of the blade for the purpose of reducing vibrations of the blade, or which is provided or configured or used for this purpose.

In one embodiment, advantageous contact kinematics and/or dynamics, in particular narrow clearances and/or material-integral contact surfaces, may be provided hereby and the vibration reduction thus (further) improved.

In one embodiment, the area of the blade, and the thus jointly generatively manufactured area of the guide, the supporting structure and/or the body or one or multiple of the bodies, include metal; in one refinement, they are generatively manufactured from metal powder as the source material.

In one embodiment, advantageous dynamics are provided hereby, and the vibration reduction is thus (further) improved.

In one embodiment, the guide has one or multiple open hollow spaces and/or one or multiple closed hollow spaces, in which the body or one or multiple of the bodies is or are situated or accommodated in one or multiple degrees of freedom.

An advantageous guidance may be provided by hollow spaces.

In one embodiment, non-solidified source material may be advantageously removed through open hollow spaces, in particular during generative manufacture.

In one embodiment, the accommodated body or bodies may be protected by closed hollow spaces against working fluid of the turbomachine, and/or their dynamics, in particular aerodynamics, may be improved.

In one refinement, a maximum outer diameter of the body or one or multiple of the bodies, for example an outer diameter of a spherical body, is (in each case) larger than a maximum inner dimension or inside width of a through-opening of a wall of the open hollow space, in particular larger than an inner diameter of a circular through-opening.

In one embodiment of the body or bodies, non-solidified source material may be advantageously removed herethrough in a captive manner and even during generative manufacture.

In one refinement, one or the maximum outer dimension of the body or one or multiple of the bodies is alternatively or additionally larger (in each case) than a maximum clearance of this body in the guide, in particular in one or multiple translatory degree(s) of freedom, in particular at least twice as large as the maximum (translatory) clearance.

Certain vibrations, in particular vibration modes, may be particularly advantageously reduced by such large bodies in relation to their maximum clearance.

In one refinement, one or the maximum outer dimension of the body or one or multiple of the bodies is smaller (in each case) than a maximum clearance of this body in the guide, in particular in one or multiple translatory degree(s) of freedom, in particular at most half the size of the maximum (translatory) clearance.

Other vibrations, in particular vibration modes, may be particularly advantageously reduced due to such small bodies in relation to their maximum clearance.

In one embodiment, the body or bodies, the guide and/or the supporting structure is/will be or are/will be situated in an, in particular closed, cavity, which, in turn, is defined or limited entirely or partially by the blade, in particular the generatively manufactured area of the blade.

In one embodiment, the guide, supporting structure and/or body, in particular also in open hollow spaces, may be protected hereby against working fluid of the turbomachine. In one refinement, the cavity is or will be enclosed by another component, in particular a housing or a rotor of the turbomachine, in particular in that the blade is or will be in particular indestructibly detachably or non-indestructibly detachably fastened hereto.

### BRIEF DESCRIPTION OF THE DRAWINGS

Further advantageous refinements of the present invention are derived from the subclaims and the following description of preferred embodiments, showing a partially schematic illustration.

FIG. 1 shows a section of a turbomachine blade system of a gas turbine according to one embodiment of the present invention; and

FIG. 2 shows a section of a turbomachine blade system of a gas turbine according to another embodiment of the present invention.

### DETAILED DESCRIPTION

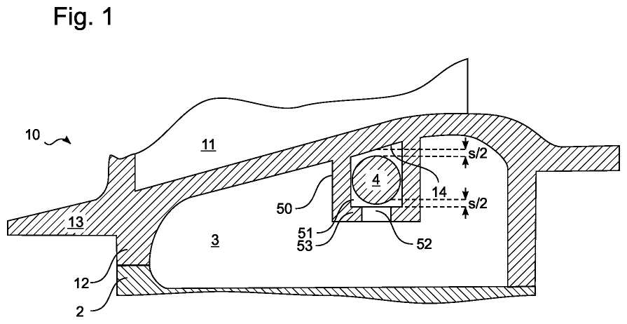

FIG. 1 shows a section of a turbomachine blade system of a gas turbine according to one embodiment of the present invention, including a moving or guide blade 10, of which one section of a vane 11, a blade root 12 and a shroud 13 situated thereon are illustrated in FIG. 1.

Blade root 12 is situated on a housing or rotor 2 and defines a closed cavity 3 therewith.

Situated in cavity 3 is a guide 50 for movably guiding a body 4 to reduce vibrations of blade 10 due to multiple impact contacts therewith, the cavity including an open hollow space 51, in which spherical body 4 is situated with clearance in a translatory degree of freedom (vertical in FIG. 1) and three rotational degrees of freedom, one part of blade root 12 or shroud 13 having or forming a contact surface 14 for contacting body 4.

As is indicated in the partially schematic representation in FIG. 1, the outer diameter of spherical body 4 is larger than a maximum inner diameter or inside width of a through-opening 52 of a wall 53 of the guide or the open hollow space and is also larger than a maximum clearance s of body 4 in guide 50 or hollow space 51.

Vane 11, blade root 12, shroud 13, (wall 52 of) guide 50 or hollow space 51 and (impulse) body 4 will be or are generatively manufactured together from metal powder. Body 4, in particular, may be captively manufactured or situated in hollow space 51 in one work step. By subsequently connecting blade root 12 to the housing or rotor 2 or cavity 3 defined hereby, body 4 is advantageously protected against working fluid of the gas turbine in open hollow space 51.

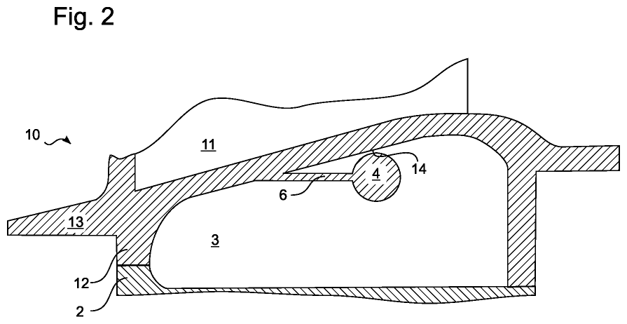

In a manner corresponding to FIG. 1, FIG. 2 shows a section of a turbomachine blade system of a gas turbine according to another embodiment of the present invention. Corresponding features are identified by identical reference numerals, so that reference is hereby made to the preceding description and only the differences are discussed below.

In the embodiment in FIG. 2, spherical body 4 is not mounted in a guide but rather elastically supported or connected on blade root 12 in cavity 3 by a thin-walled supporting structure 6, which will be or is generatively manufactured from metal powder together with vane 11, blade root 12, shroud 13 and (impulse) body 4.

Body 4, in particular, may in turn be captively manufactured or situated in cavity 3 in one work step. By subsequently connecting blade root 12 to the housing or rotor 2, body 4 and supporting structure 6 are, in turn, advantageously protected against working fluid of the gas turbine.

While the description above explained exemplary embodiments, it should be pointed out that a plurality of modifications is possible.

For example, body 4 in the embodiments in FIGS. 1, 2 may also be situated in vane 11 or a diametrically opposed (additional) shroud (not illustrated) instead of on a side of blade root 12 facing away from the vane, which is or will be generatively manufactured at least partially together with the guide or supporting structure for this purpose.

Additionally or alternatively, guide 50, in particular in the embodiment in FIG. 1, or supporting structure 6 in the embodiment in FIG. 2, which each define (impact) kinematics, may be eliminated, and (impulse) body 4 accommodated in cavity 3 may be or become generatively manufactured together with (at least) one area of blade 10, for example blade root 12, shroud 13 and/or vane 11 or a part thereof.

Moreover, it should be pointed out that the exemplary embodiments are only examples which are not intended to limit the scope of protection, the applications and the design in any way. Rather, the description above gives those skilled in the art a guideline for implementing at least one exemplary embodiment, various modifications being possible, in particular with respect to the function and positioning of the described components, without departing from the scope of protection as it is derived from the claims and feature combinations equivalent to the claims.

### LIST OF REFERENCE NUMERALS

10 blade
11 vane
12 blade root
13 shroud
14 contact surface
2 housing/rotor
3 cavity
4 (impulse) body
50 guide
51 hollow space
52 opening
53 wall
6 supporting structure
s (maximum) clearance

What is claimed is:

1. A turbomachine blade system comprising:
at least one blade;
a cavity radially inward of the blade; and
at least one moving body for reducing the vibrations of the blade and located in the cavity, at least one area of the body being generatively manufactured together with at least one area of the blade, the moving body being a spherical body with a diameter larger than a maximum clearance in an axial or circumferential direction of the spherical body in the cavity.

2. The turbomachine blade system as recited in claim 1 wherein the body is an impulse body for reducing the vibrations of the blade through multiple impact contacts.

3. The turbomachine blade system as recited in claim 1 wherein the generatively manufactured area of the blade has a contact surface for contacting the body.

4. The turbomachine blade system as recited in claim 1 wherein the generatively manufactured area of the blade, or the generatively manufactured area of the body includes metal.

5. The turbomachine blade system as recited in claim 4 wherein the generatively manufactured area of the blade or the generatively manufactured area of the body is manufactured from metal powder.

6. The turbomachine blade system as recited in claim 1 wherein the body is in a closed hollow space defined by a guide connected to the blade, the body being situated with the maximum clearance in the axial and circumferential direction in the closed hollow space.

7. The turbomachine blade system as recited claim 1 wherein a maximum outer dimension of the body is larger than a maximum inner dimension of a through-opening of a wall of a hollow space defined by a guide in the cavity, the hollow space being an open hollow space.

8. The turbomachine blade system as recited in claim 1 wherein the body, a guide or the supporting structure is situated in the cavity, the cavity at least partially defined by the blade.

9. The turbomachine blade system as recited in claim 1 wherein the body, a guide or the supporting structure is situated in the cavity, the cavity being a closed cavity at least partially defined by the generatively manufactured area of the blade.

10. The turbomachine blade system as recited in claim 1 wherein the blade is a moving blade.

11. The turbomachine blade system as recited in claim 1 wherein the blade is a guide blade.

12. The turbomachine blade system as recited in claim 1 wherein the generatively area of the blade is on a vane or blade root or a shroud.

13. A compressor or turbine stage of a gas turbine comprising the turbomachine blade system as recited in claim 1.

14. A turbomachine comprising at least one turbomachine blade system as recited in claim 1.

15. A gas turbine comprising the turbomachine as recited in claim 14.

16. A method for manufacturing a turbomachine blade system as recited in claim 1 wherein the area of the guide, the supporting structure or the body is generatively manufactured together with the area of the blade.

17. A turbomachine blade system comprising:
at least one blade;
a cavity radially inward of the blade; and
at least one moving body for reducing the vibrations of the blade and located in the cavity, at least one area of the body being generatively manufactured together with at least one area of the blade, the moving body being a spherical body connected to the cavity via a supporting structure, a diameter of the moving body being larger than a minimum thickness of the supporting structure.

18. The turbomachine blade system as recited in claim 17 wherein the minimum thickness is at most 50% of the diameter.
